(19) United States
(12) Patent Application Publication
(10) Pub. No.: US 2026/0016205 A1
(43) Pub. Date: Jan. 15, 2026

(54) System and Method for Calculation of Thermodynamic Properties from Anomalous Reference Data

(71) Applicant: Mitsubishi Electric Research Laboratories, Inc., Cambridge, MA (US)

(72) Inventors: Christopher Laughman, Waltham, MA (US); Vedang Deshpande, Attleboro, MA (US); Ankush Chakrabarty, Bedford, MA (US); Scott Bortoff, Brookline, MA (US); Hongtao Qiao, Wakefield, MA (US)

(73) Assignee: Mitsubishi Electric Research Laboratories, Inc., Cambridge, MA (US)

(21) Appl. No.: 18/949,487

(22) Filed: Nov. 15, 2024

Related U.S. Application Data
(60) Provisional application No. 63/668,947, filed on Jul. 9, 2024.

(51) Int. Cl. F25B 49/00; F25B 49/02; G06F 17/17; G06F 17/18

(52) U.S. Cl. CPC F25B 49/005; F25B 49/02; G06F 17/17; G06F 17/18; F25B 2500/19; F25B 2700/21

(57) ABSTRACT

A system controls a vapor compression system containing multicomponent refrigerant mixture by modifying the actuator commands via an output interface, that realizes thermofluid property functions and their derivatives as interpolation functions constructed from anomalous reference thermodynamic property data. The system includes an interface configured to receive measurement data from sensors, a memory configured to store thermofluid property data and computer-executable programs including interpolation functions, and a processor for performing the computer-implemented method. The processor is configured to take as input two thermofluid property variables, and compute using interpolation functions a third thermofluid property variable and its derivatives with respect to input thermofluid property variables. Interpolation functions are constructed from anomalous reference thermodynamic property data by eliminating and replacing anomalous data points with estimated values matching expected physical properties of the fluid using domain-informed knowledge and using cleaned anomaly-free property data for calculating optimal coefficients of the interpolation functions.

### TECHNICAL FIELD

This disclosure relates to a system and method for controlling and optimizing the performance of vapor compression systems, more specifically, to a system and method for estimating thermofluid properties of multicomponent refrigerant mixtures used for the control and performance optimization of vapor compression systems based on calculation of thermodynamic properties from anomalous reference data.

### BACKGROUND

Thermofluid property functions are an essential component of any simulation-based model of a thermofluid system, such as a vapor compression cycle, that are used in a wide variety of equipment such as air conditioners, heat pumps, refrigerators, and so forth to implement controls, diagnostic functionality, and performance monitoring in commercially available products. These thermofluid systems may employ either pure fluids, which consist of one chemical species (e.g., the refrigerant R32), or they may employ a multicomponent refrigerant mixture, which is a mixture of two or more pure refrigerant fluids. For example, the refrigerant mixture R454C is composed of two refrigerant fluids R32 and R1234YF. Whereas pure fluids have historically been used for the majority of commercially-available equipment that incorporates refrigerants, recent awareness about the environmental impact of refrigerants has brought issues of refrigerant selection to the forefront of system design considerations. While these previous generations of refrigerants have been effective in space conditioning applications, they often contribute significantly to climate change. These trends have motivated significant research and study into multicomponent refrigerant mixtures which have a lower global warming impact than conventional fluids.

These thermofluid property functions relate thermodynamic property variables (such as temperature, pressure, density, and specific enthalpy) and transport property variables (such as viscosity, thermal conductivity, and surface tension) to one another, and provide important physical constraints on the behavior of the system. A property function takes as input a number of independent thermofluid property variables, such as pressure and specific enthalpy, and produces as output a single thermofluid property variable such as density, viscosity, or surface tension. Without accurate thermofluid property functions, a system model used for control or optimization of a thermofluid system will not be consistent with actual system behavior and therefore will be of limited use in solving any practical control or optimization problem.

Thermofluid property variables for a fluid of fixed composition, either a pure fluid or a multicomponent mixture, in thermodynamic equilibrium can be calculated as a function of two independent variables: a mixture variable and a second variable. For example, any thermofluid property variable for a fluid of fixed composition can be calculated as a function of the pressure and the specific enthalpy, or alternatively as a function of the temperature and the specific entropy. Other combinations of independent variables are also possible.

Geometrically, a thermofluid property function for a fluid of fixed composition can be considered as a two dimensional surface embedded in a three dimensional space, with points on this surface having coordinates consisting of the two input thermofluid property variables, and the one output thermofluid property variable. Mathematically, the domain of such a thermofluid property function is defined as the two dimensional span of the two input thermofluid property variables, each over a range of interest which depends on the particular thermofluid system. For many thermofluid systems, such as vapor compression systems, the domain includes values of the two input thermofluid property variables that correspond to one or more of the fluid's states, such as the vapor state, the supercritical state, or the two-phase state (in which both liquid and vapor states are present). The collection of points in the domain for which the fluid is in the liquid state is referred to as the liquid region, the collection of points in the domain for which the fluid is in the vapor state is referred to as the vapor region, the collection of points in the domain for which the fluid is in the two-phase state is referred to as the two-phase region, and the collection of points in the domain for which the fluid pressure is higher than the critical pressure is referred to as the supercritical region. The boundary between the liquid region and two-phase region in the domain is referred to as the liquid saturation curve, or the bubble point curve for multicomponent mixtures. The boundary between the vapor region and two-phase region in the domain is referred to as the vapor saturation curve, or the dew point curve for multicomponent mixtures. These curves intersect smoothly at the critical point of the fluid. Their union is referred to as the saturation curve. Thus, the saturation curve is the boundary between the two-phase region and the single-phase region; where the single-phase region is defined as the union of the liquid region and the vapor region. The saturation curve is distinguished because its image under a thermofluid property function is, geometrically speaking, a non-smooth edge when considering the thermofluid property function as a surface in three-dimensional space. The thermofluid property function is continuous, but not continuously differentiable, for all points on the saturation curve. For all other points in the domain, the thermofluid property function is continuously differentiable as a function of the two input thermofluid property variables.

Control or optimization applications for thermofluid systems with fluids of fixed composition often make use of the derivatives of the thermofluid property function with respect to the two input fluid property variables, which are often chosen as output variables of fluid property functions. The derivatives exist and are continuous over the domain except for values of the input thermofluid property variables on the saturation curve. The derivatives are discontinuous at the saturation curve, and the change in the derivative of these output thermofluid property variables across the saturation curve can be several orders of magnitude. For many thermofluid systems, such as vapor compression cycles, it is important to compute these derivatives accurately at values of the two input thermofluid property variables near the saturation curve, and on both sides of the saturation curve.

There are two fundamental metrics that are important for thermofluid property functions: accuracy and computational efficiency. First, the accuracy of a thermofluid property function is of clear importance, as the function's output thermofluid property variable should closely match experimentally measured data to ensure that system models that use these fluid property functions accurately predict the physical system behavior. Second, thermofluid property functions must also be computationally efficient, as they may be evaluated many times during a computer simulation of a system model. By some estimates, more than 70% of the computation time for a system simulation of a vapor compression system is spent evaluating thermofluid property functions. Improvements in computational efficiency of the thermofluid property functions will therefore have significant benefits by reducing the computational time required for a thermofluid system simulation. For thermofluid system models that have many thousands of equations and variables, reducing simulation time is of important practical value.

A few different approaches for computing thermofluid properties for either pure fluids or for multicomponent mixtures exist as prior art. Some approaches are based upon various equations that are derived from the theory of thermodynamics. The thermofluid property function may be realized by solving these equations using iterative methods that are intended to converge to a value of the output thermofluid property variable. These methods are realized in various software packages, which are referred to herein as Thermodynamic Property Generators. REFPROP and CoolProp are a couple of examples of Thermodynamic Property Generators that are widely used for computing thermofluid properties. While iterative methods implemented in such Thermodynamic Property Generators are intended to be general approaches that work for a wide variety of working fluids, they are computationally inefficient for the direct use in simulation models that are to be used for optimization or control. The importance of thermodynamic properties to a wide variety of simulation, control, and optimization problems has motivated a variety of prior efforts to develop fast and accurate methods for calculating these quantities.

A common approach to model property functions involves characterizing them using smooth functions such as polynomial interpolation that are built from the reference property data obtained from Thermodynamic Property Generators. Such interpolation-based property functions have several desirable characteristics including smoothness, differentiability, good accuracy with respect to the reference data, and computational efficiency, which are needed in models used for control and optimization. However, the quality and accuracy of interpolation-based methods are directly dependent on the reference data they are built on. Even a small amount of noise or a few anomalous data points in the reference data can greatly deteriorate the accuracy of the interpolation-based property functions.

Unfortunately, reference property data sets are known to suffer from noise and anomalies. The overall structure of the methods used in Thermodynamic Property Generators such as REFPROP generally involves a series of nested iterative root-finding computations that enforce physical constraints that apply in the thermodynamic phase space, e.g., the equality of pressures, temperatures, and fugacities in flash calculations. As is the case for any nonlinear root-finding problem, the success of these algorithms is highly dependent upon the shape of the function under study and initial guesses for the root, and these algorithms often rely on carefully tuned parameters to avoid local minima or limit cycles during convergence. Despite the care taken in the implementation of these numerical methods, however, these property calculation routines thus sometimes return erroneous values at specific state points over the range of operation due to poor local numerical behavior. Furthermore, because these methods are iterative algorithms, they include a stopping criterion, and therefore small errors can be introduced into the computed output thermofluid property value if the iteration is terminated prematurely via this stopping criterion. If these are values that are numerically differentiated in order to compute an approximate derivative, then the small errors can be amplified to the point of being unacceptably large, especially in the region near the saturation curve. Further, these iterative methods can fail to converge for certain values of the two independent thermofluid property variables and can therefore result in missing or anomalous data points in the reference data sets.

Multicomponent refrigerant mixtures are particularly prone to non-physical anomalies in their reference property data sets generated from Thermodynamic Property Generators because refrigerant mixtures tend to be harder to describe using first principles methods than pure refrigerants, due to the numerical challenges often encountered during model implementation. This presents a significant challenge for the development of next-generation vapor compression cycles which will rely upon multicomponent refrigerant mixtures to reduce the climate impact of the working fluids. Therefore, desirable characteristics of interpolation-based property models for practical implementation in simulation models coupled with their direct dependencies on the reference property data, motivate the efforts to obtain clean, i.e., anomaly-free property data from the anomalous reference property data provided by Thermodynamic Property Generators.

Different modeling approaches for characterizing property functions have been studied in a substantial body of prior work, but no extant papers describe systematic approaches to accommodate anomalous reference property data in developing thermodynamic property models. Much of the existing relevant literature examines the use of different approximation methods to represent the property curves and surfaces based on given reference data to gain computational advantages. For instance, Kunick et al. (2018) develop a spline-based approach to represent the property surfaces in a computationally efficient manner. Li et al. (2018) extend these spline-based methods and applies them specifically to vapor-compression cycles, while Aute et al (2014) use Chebyshev polynomials to approximate these surfaces for similar applications. U.S. Ser. No. 11/739,996B2 describes a coordinate transformation for property variables which results in better accuracy and consistency of spline-interpolation based property models. However, an anomaly-free reference property data set is a pre-requisite for all approaches mentioned above, these methods cannot accommodate noisy or anomalous reference property data sets of multicomponent refrigerant mixtures.

Consequently, there is a need for a system and method of calculating thermofluid property variables using thermofluid property functions that can be built from anomalous reference property data sets, and have superior performance in terms of accuracy and computational efficiency.

### SUMMARY

It is an object of some embodiments to provide a system and method for calculating thermofluid properties for purposes of controlling or optimizing the behavior of a thermofluid system. It is further an object of some embodiments to provide a system and a method for calculating thermofluid properties of a refrigerant for purposes of controlling or optimizing the behavior of a vapor compression system. It is another object of some embodiments to provide a method for using a first thermofluid property variable, a second thermofluid property variable, and a thermofluid property function to calculate a third thermofluid property variable. These thermofluid property variables may be used to describe aspects of the behavior of a thermofluid system in order to determine its performance under a set of conditions. Examples of controllers or optimizers include but are not limited to model predictive control (MPC), which uses a dynamic model of a thermofluid system together with real-time optimization to regulate system performance, or an extended Kalman filter (EKF), which generates optimal estimates of the states of a model of a thermofluid system based upon a set of measurements.

Some embodiments of the present disclosure are based on recognition that thermodynamic property models of refrigerants play an essential role in dynamic physics-based models of vapor-compression cycles used for model-based design to reduce development times and increase system performance. As these refrigerant models enforce algebraic constraints that describe the nonlinear relations between the property variables, such as pressure, temperature, density, and specific enthalpy, the accuracy of the overall system model is strongly dependent upon the accuracy of the property models. Model simulation speed is also governed by the speed of the property models in many cases; for instance, by some estimates, more then 70% of the computation time for a model simulation is spent evaluating thermofluid property functions.

Accordingly, some embodiments are based upon the realization that use of polynomial-interpolations for thermofluid property function representation can meet the stringent requirements of speed, accuracy, and smoothness needed for property models used in control and optimization applications. Interpolation based function approximation aims to approximate the given discrete data points using polynomial basis functions of desired order that can satisfy continuity and smoothness conditions within a specified domain. The reference data of thermodynamic property variables needed for construction of interpolation functions can be generated from iterative methods implemented in general software tools such as REFPROP.

Unfortunately, multicomponent refrigerant mixtures tend to be harder to describe using first principles methods than pure refrigerants, due to the numerical challenges often encountered during model implementation. As a result, despite the care taken in the implementation of iterative numerical methods within Thermodynamic Property Generators, these property calculation routines for multicomponent refrigerant mixtures sometimes return erroneous values at specific state points over the range of operation due to poor local numerical behavior. Consequently, reference data sets generated for multicomponent refrigerant mixtures often suffer from non-physical anomalies as well as small scale noise. The noise and anomalies present in the reference data can severely affect the overall accuracy of interpolation-based property functions. Moreover, anomalies in reference data may lead to property functions that are inconsistent with the physical behavior of the system and may cause simulation failures.

Some embodiments are based on the realization that reference data should be free of noise and anomalies before it can be used for construction of interpolation-based property models. Accordingly, it is object of some embodiments to obtain cleaned data that is free of anomalies from anomalous reference property data obtained from Thermodynamic Property Generators.

Accordingly, embodiments are based on construction of interpolation function calculator by generating anomalous reference thermodynamic property data using a Thermodynamic Property Generators; identifying anomalous data points in the reference property data; eliminating anomalous data points and replacing them with estimated values that better match the expected physical properties of the fluid using domain-informed knowledge; calculating optimal coefficients of the interpolation function with respect to the cleaned anomaly-free thermodynamic property data.

Accordingly, one embodiment discloses a control system for controlling a vapor compression system having a multicomponent refrigerant mixture and actuators, including an input interface configured to receive setpoints of the vapor compression system from a user input and measurement data from sensors arranged in the vapor compression system; a memory configured to store fluid property data of a fluid flowing in the vapor compression system and computer-executable programs including a thermofluid property calculator and an interpolation function calculator, where the thermofluid property calculator and interpolation function calculator are constructed by generating reference thermodynamic property data; identifying anomalous data points in the reference thermodynamic property data; cleaning the reference thermodynamic property data by one or a combination of eliminating the anomalous data points and replacing the anomalous data points with estimated values matching expected physical properties of the fluid to obtain cleaned anomaly-free thermodynamic property data; and calculating optimal coefficients with respect to the cleaned anomaly-free thermodynamic property data; and a processor configured to: compute, with respect to the setpoints, a pair of input thermofluid property variables from the measurement data or from the stored fluid property data; compute a third thermofluid property variable using the interpolation function calculator; compute derivatives of the third thermofluid property variable with respect to the pair of input thermofluid property variables using the interpolation function calculator; compute control data from the measurement data and the third thermofluid property variable and the derivatives of the third thermofluid property variable; and transmit, via an output interface, the computed control data including instructions that control the actuators operating the vapor compression system to the vapor compression system.

Another embodiment discloses a non-transitory computer-readable medium storing computer-executable programs including instructions that, when executed by a processor, cause a controller connected to a vapor compression system having multicomponent refrigerant mixture and actuators through input and output interfaces, to: receive, via the input interface, setpoints of the vapor compression system from a user input and measurement data from sensors arranged in the vapor compression system; compute, with respect to the setpoints, a pair of input thermofluid property variables from the measurement data or from fluid property data stored in a memory; compute a third thermofluid property variable using an interpolation function calculator constructed by generating reference thermodynamic property data; identifying anomalous data points in the reference thermodynamic property data; cleaning the reference thermodynamic property data by one or a combination of eliminating the anomalous data points and replacing the anomalous data points with estimated values matching expected physical properties of the fluid to obtain cleaned anomaly-free thermodynamic property data; and calculating optimal coefficients with respect to the cleaned anomaly-free thermodynamic property data; compute derivatives of the third thermofluid property variable with respect to the pair of input thermofluid property variables using the interpolation function calculator; compute control data from the measurement data and the third thermofluid property variable and the derivatives of the third thermofluid property variable; and transmit, via the output interface, the computed control data including instructions that control the actuators operating the vapor compression system to the vapor compression system.

### BRIEF DESCRIPTION OF THE DRAWINGS

The accompanying drawings, which are included to provide a further understanding of the disclosure, illustrate embodiments of the disclosure and together with the description serve to explain the principle of the disclosure. The drawings shown are not necessarily to scale, with emphasis instead generally being placed upon illustrating the principles of the presently disclosed embodiments.

FIG. 1 shows a block diagram of a vapor compression cycle with a controller, sensors, valve, compressor, and heat exchangers, according to embodiments of the present disclosure;

FIG. 2 shows a block diagram of a controller/optimizer controlling a vapor compression cycle system, according to embodiments of the present disclosure;

FIG. 3 shows a plot of saturation curve as a function of input thermofluid property variables specific enthalpy h and pressure P, with the saturation curve dividing the region of interest into the two-phase region and the single-phase region;

FIG. 4A shows an example of the density surface p computed by REFPROP over a wide domain of conditions for the refrigerant mixture R454C as a function of pressure P and specific enthalpy h, according to embodiments of the present disclosure;

FIG. 4B is an example showing an additional view of the density data as a function of thermodynamic quality q in the two-phase region, according to embodiments of the present disclosure;

FIG. 5 shows a flowchart describing a general procedure for constructing interpolation-based refrigerant property models that satisfy the stringent requirements of speed, accuracy, consistency, and smoothness, according to embodiments of the present disclosure;

FIG. 6A describes an algorithm to identify anomalous data points from the reference property data corresponding to the step 620 in FIG. 5, according to embodiments of the present disclosure;

FIG. 6B and FIG. 6C illustrate the anomaly identification algorithm described in FIG. 6A, according to embodiments of the present disclosure;

FIG. 7A describes a method to eliminate anomalous data points and replace them with estimated values that better match the expected physical properties of the refrigerant fluid using domain-informed knowledge, according to embodiments of the present disclosure;

FIG. 7B, and FIG. 7C show some results obtained based on the algorithm of an anomaly elimination method, according to embodiments of the present disclosure;

FIG. 8A shows a method 900 for estimating cleaned data matrix M from a reference data matrix M, according to embodiments of the present disclosure;

FIG. 8B shows an example result demonstrating the efficacy of the method 900 on the same reference data that was used to generate FIG. 4A;

FIG. 9 illustrates an exemplary method to calculate a thermodynamic property p, according to embodiments of the present disclosure; and

FIG. 10 is a block diagram of a digital computer including the thermofluid property function calculator, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Various embodiments of the present disclosure are described hereafter with reference to the figures. It would be noted that the figures are not drawn to scale elements of similar structures or functions are represented by like reference numerals throughout the figures. It should be also noted that the figures are only intended to facilitate the description of specific embodiments of the disclosure. They are not intended as an exhaustive description of the disclosure or as a limitation on the scope of the disclosure. In addition, an aspect described in conjunction with a particular embodiment of the disclosure is not necessarily limited to that embodiment and can be practiced in any other embodiments of the disclosure.

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance” and “such as,” and the verbs “comprising,” “having,” “including,” and their other verb forms, when used in conjunction with a listing of one or more components or other items, are each to be construed as open ended, meaning that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

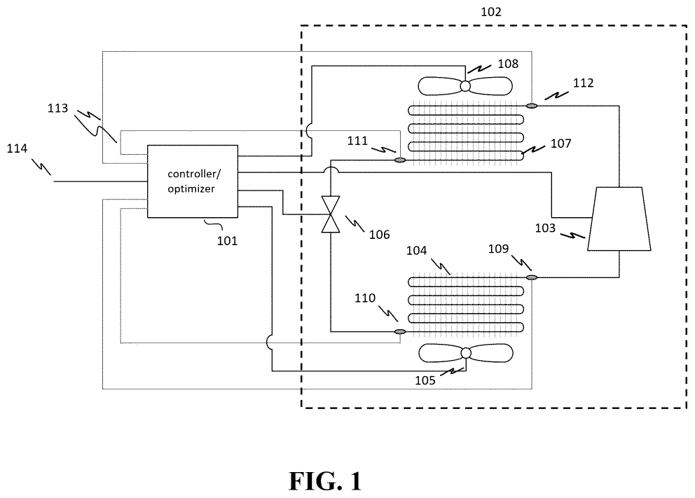

FIG. 1 shows a block diagram of a vapor compression cycle with a controller, sensors, valve(s), compressor, fans, and heat exchangers. In some cases, the vapor compression cycle may be referred to as a vapor compression system or a vapor compression circuit, and the controller may be referred to as an optimizer. The sensors, valve(s), compressor, and heat exchangers are arranged in the vapor compression circuit. The controller is configured to receive the measured data from the sensors while the vapor compression system is operating. The controller controls the valves, the compressor and the heat exchangers to achieve a predetermined condition of a fluid that flows in the vapor compression circuit.

The figure illustrates a diagram of a vapor compression system 102 with variable actuators which also incorporates a controller 101 that regulates its behavior. The vapor compression cycle (system) 102 comprises, at a minimum, a set of four components: a compressor 103, a condensing heat exchanger 104, an expansion device 106, and an evaporating heat exchanger 107. Heat transfer from the condensing heat exchanger is promoted by use of fan 105, while heat transfer from the evaporating heat exchanger 107 is promoted by the use of fan 108. This system has variable actuators, such as a variable compressor speed, variable expansion valve position, and variable fan speeds. Of course, there are many other alternate equipment architectures to which this disclosure pertains with multiple heat exchangers, compressors, valves, and other components such as accumulators or reservoirs, pipes, and so forth, and the discussion of a simple vapor compression cycle is not intended to limit the scope or application of this disclosure to systems whatsoever.

The function of a vapor compression cycle is well-known, but is described briefly here. The variable speed compressor 103 compresses a low pressure, low temperature vapor-phase fluid called the refrigerant to a high pressure, high temperature vapor state, after which it passes into the condensing heat exchanger 104. As the refrigerant passes through this heat exchanger, the enhanced heat transfer promoted by variable speed fan 105 causes the high-temperature, high pressure refrigerant to transfer its heat to the ambient air, which is at a lower temperature. As the refrigerant transfers thermal energy to the ambient environment, it gradually condenses until all of the refrigerant is in a high pressure, low temperature liquid state. After it leaves the condensing heat exchanger 104, the refrigerant passes through a variable orifice expansion valve 106 and expands to a low pressure boiling state, from which it enters an evaporating heat exchanger 107. Because the air passing over the evaporating heat exchanger is warmer than the refrigerant itself, this refrigerant gradually evaporates as it passes through this heat exchanger, so that it completely evaporates before it exits at a low pressure, low temperature state. The evaporation process is further facilitated by the enhanced heat transfer promoted by variable speed fan 108. The refrigerant reenters the compressor in this low pressure, low temperature state, at which point the cycle repeats.

In this system, the controller 101 is configured to transmit control data including instructions that control operations of actuators, such as the components 103, 105, 106, and 108 of the vapor compression system 102 including compressors, valves and motor fans to achieve the performance of a vapor compression system 102 in response to the setpoints inputted via an interface by a user input. The controller 101 obtains measurements from sensors about the state of the system that is used to provide information about its performance. Sensor 109 indicates the use of temperature, pressure, or other sensors to measure the state of the refrigerant entering the condensing heat exchanger, while sensor 110 indicates the use of similar measurement modalities to measure the state of the refrigerant leaving the condensing heat exchanger. Similarly, sensor 111 measures the state of the refrigerant entering the evaporating heat exchanger, while sensor 112 measures the state of the refrigerant exiting the evaporating heat exchanger. The controller or optimizer then uses these measurements 113 to evaluate the operation of the system according to factory-provided setpoints 114 inputted by a user using an input interface, and modifies the value of actuator inputs 103, 105, 106, and 108 according to the measurements and the specified objectives or constraints that are possessed by the controller. As before, these indicated measurements and architecture are not intended to be limiting, but rather indicate the overall structure of such systems.

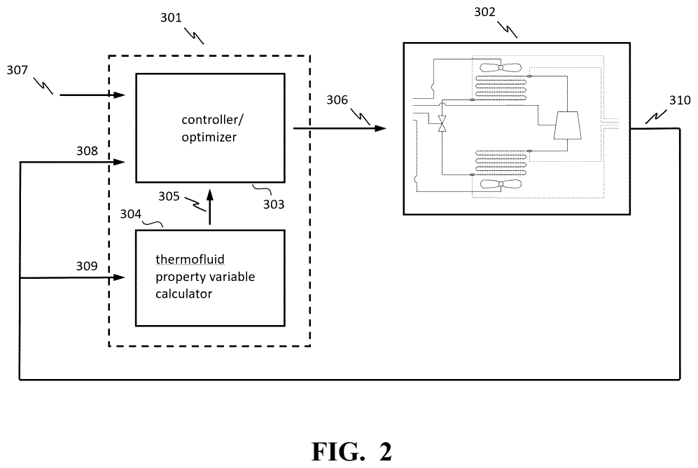

FIG. 2 shows a block diagram of the controller 301 illustrating the use of the thermofluid property variable calculator 304 supplying thermofluid property variables 305 for use by the control controller/optimizer 303 in order to modify the behavior of the vapor compression cycle (system) 302. The figure illustrates the structure of a specific controller or optimizer 303 for a vapor compression cycle (circuit) 302 that has two distinct components: a control block 303 and a thermofluid property calculation block 304. Measurements of this system 310 are obtained and subsets of this information are passed to the control block 303 and the thermofluid property calculation block 304. The control block 303 is configured to receive user input 307 and system information 308 and calculate the actuator inputs 306. A variety of different methods may be used in the control block, such as proportional-integral (PI) controllers or a gradient-based optimization algorithm. This block 303 does rely upon information about the system that is not immediately available from the measurements or system information 308. For example, model predictive control (MPC) uses information from a model of the system to predict the behavior of the system over a time horizon and then optimize the actuator inputs to satisfy an objective function and operating constraints. This information about the system, which may include thermofluid property variables 305, is provided by the thermofluid property calculation block 304, which may compute a variety of thermofluid property functions and thermofluid property variables that are used in the control block 303. The thermofluid property computation block 304 may compute this property information from a set or subset of the system measurements 309. Alternatively, the control block 303 may include of an optimization algorithm that is designed to optimize the system performance according to some metric. In this case, the gradient of the model at the given operating point is needed to optimize the system behavior. These methods therefore require the fast, accurate, and consistent implementation of thermofluid property functions so that they can be used in real-time by the controller 303.

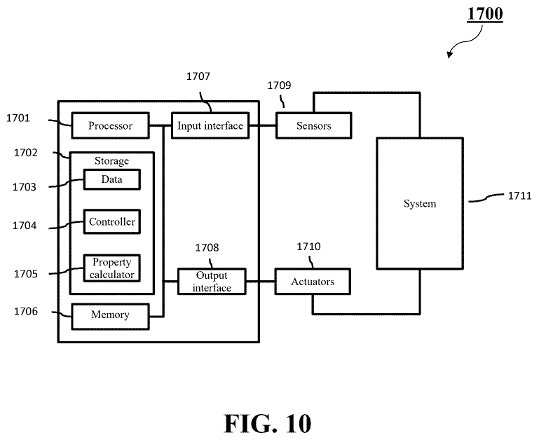

In this disclosure, some embodiments of thermofluid property functions are described. Either may be used in a controller or optimizer (illustrated as controller/optimizer 101 in FIG. 1, controller/optimizer 303 in FIG. 2 or controller 1704 in FIG. 10) or with a set of measurements from the physical system (sensors 110, 111 and 112 in FIG. 1 or sensors 1709 in FIG. 10). Also described is the process of constructing the embodiments of thermofluid property functions from available data.

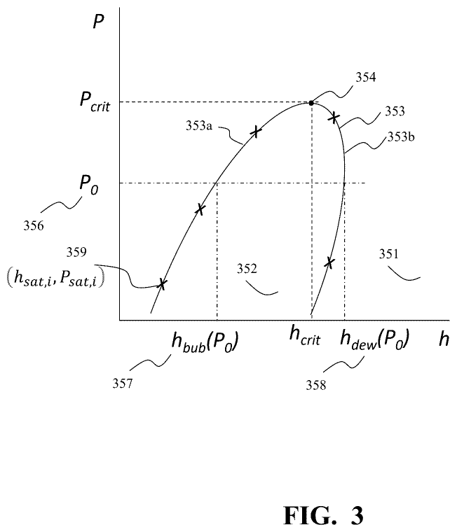

FIG. 3 shows a plot of saturation curve as a function of input thermofluid property variables specific enthalpy h and pressure P. In general, a refrigerant like R454C, can be described as consisting of two regions: a single-phase region 351, which comprises the liquid region, the vapor region, and the supercritical region, and a two-phase region 352. The saturation curve 353, which is a one-dimensional curve embedded in a two-dimensional space, represents the boundary between these regions characterizing the inception of a boiling or condensing process as state of a fluid volume in thermodynamic equilibrium moves from single-phase region 351 to two-phase region 352.

The liquid saturation curve 353a is also referred to as the bubble point line; and the vapor saturation curve 353b is also referred to as the dew point line. The saturation curve 353 is union of liquid saturation curve 353a and vapor saturation curve 353b. The liquid saturation curve 353a and vapor saturation curve 353b meet at the critical point 354, which represents the upper limit of pressure P_{crit} where two-phase behavior disappears. Above this critical point, fluid exists in a homogeneous-single phase state, called the supercritical state. For an arbitrary pressure P₀ 356 smaller than the critical pressure P_{crit}, the value of specific enthalpy on bubble point line 353a is referred to as bubble point enthalpy h_{bub}(P₀) 357; and the value of specific enthalpy on dew point line 353b is referred to as dew point enthalpy h_{dew}(P₀) 358. The saturation curve 353 can be characterized by the data points (h_{sat,i}, P_{sat,i}) 359 calculated along the curve. These data points 359 can be calculated by available Thermodynamic Property Generators. The data points (h_{sat,i} P_{sat,i}) 359 can be readily used to fit a curve through them using any standard curve fitting approaches that allows analytical calculation of bubble point enthalpy h_{bub}(P₀) 357 and dew point enthalpy h_{dew}(P₀) 358 along the curve 353 for any given arbitrary pressure P₀ 356.

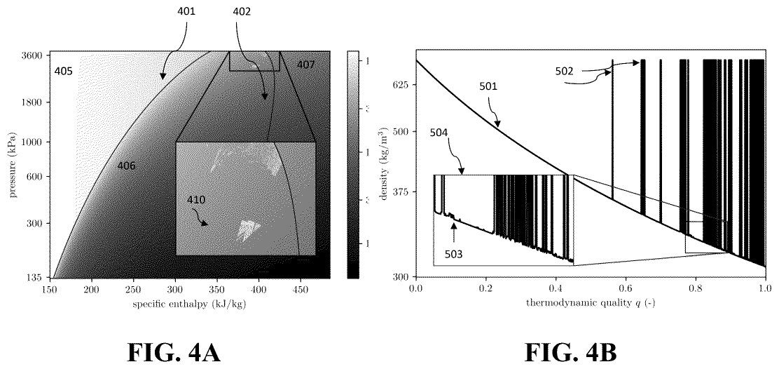

FIG. 4A shows an example of the density surface ρ computed by REFPROP over a wide domain of conditions for the refrigerant mixture R454C as a function of pressure P and specific enthalpy h. This figure illustrates a heatmap in which the darker shade corresponds to the larger refrigerant density. The bubble point line or liquid saturation curve 401 and dew point line or vapor saturation curve 402, collectively referred to as saturation curves, separate the property surface in liquid-phase region 405 where refrigerant is in liquid state, vapor-phase region 407 where the refrigerant is in gaseous state, and the two-phase region 406 wherein the refrigerant is a mixture of both liquid and vapor. While much of the density surface is smooth, anomalous data is visible in the two-phase region at pressures close to the critical point. The inset plot 410 shows a detailed view of this anomalous data.

FIG. 4B shows an additional view of the density data as a function of thermodynamic quality q in the two-phase region 406 as an example. The thermodynamic quality in two-phase regions is defined as follows:

$$q = \frac{h - {h}_{liq , VLE} ( P , h )}{{h}_{vap , VLE} ( P , h ) - {h}_{liq , VLE} ( P , h )} . \qquad ( 1 )$$

Where h_{liq,VLE}(P, h) and h_{vap,VLE}(P, h) are respectively the liquid enthalpy and vapor enthalpy under vapor-liquid equilibrium in two-phase region as a function of pressure and bulk enthalpy.

For pure fluids, the equilibrium between vapor and liquid phases is described by the equality of pressure, temperature and molar Gibbs free energy in each phase. For multicomponent refrigerant mixtures, where vapor and liquid include multiple components, the equilibrium between vapor and liquid phases is described by the equality of pressure, temperature and chemical potential for each component in each phase. It should be noted that h_{liq,VLE} and h_{vap,VLE} is only a function of pressure P for pure fluids and does not change with specific enthalpy h during boiling or condensing process. However, for multicomponent refrigerant mixtures, more volatile components have relatively higher vapor pressures and tend to evaporate readily, where less volatile components have relatively lower vapor pressures and tend to evaporate more slowly, resulting in different compositions in each phase. Consequently, h_{liq,VLE} and h_{vap,VLE} will be a function of both pressure P and specific enthalpy h. The curve 501 illustrates the density curve ρ(q) of the refrigerant R454C at a constant pressure of an exemplary value 3.785 MPa. The large-magnitude anomalous density outputs 502 are visible in the data. Relatively smaller-magnitude anomalous density outputs 503 are shown in the inset plot 504. Both large-magnitude anomalies 502 and small-magnitude anomalies or noise 503 arise due to various numerical issues such as non-convergence of iterations associated with the iterative algorithms. Even such small-magnitude anomalies 503 will result in non-physical large spikes in the density derivatives, which are often used in the formulation of the mass and energy conservation equations, that cause dynamic simulations to yield inaccurate predictions or fail.

It is noted that the requirements for a general thermodynamic property calculation package, such as REFPROP, differ from the requirements for property models used in dynamic system-level design. REFPROP must accommodate arbitrary mixtures of fluids and produce physically reasonable estimates of the fluid properties over wide ranges of operating conditions; this motivates the use of first-principles models due to a paucity of reference data for hypothetical mixtures under consideration. On the other hand, dynamic system-level design is usually conducted on a limited set of fluids that have been evaluated extensively and have been shown to meet thermodynamic criteria that are amenable for practical use. Some embodiments of the present disclosure are based on the realization that while REFPROP addresses the fluid selection problem, the requirements of the system design problem are quite different and motivate the development of specialized thermodynamic fluid property models for this application.

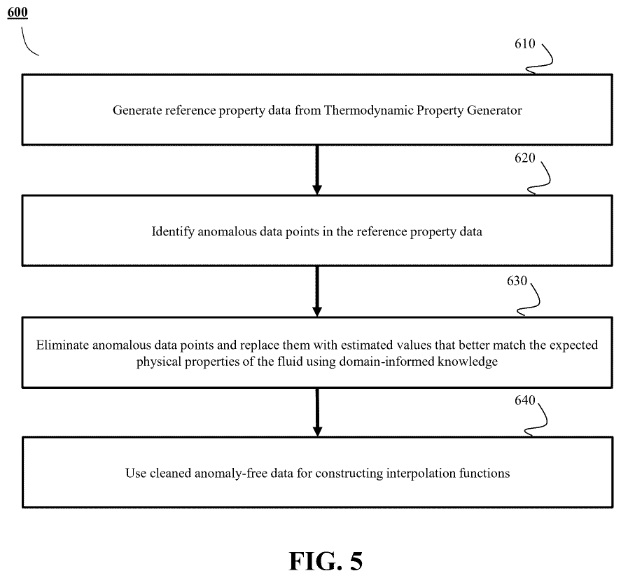

Computationally efficient refrigerant property models that satisfy the demanding requirements of dynamic cycle simulations are needed for the purposes of model-based system design. To this end, FIG. 5 presents a flowchart describing a general procedure for constructing refrigerant property models that satisfy the stringent requirements of speed, accuracy, consistency, and smoothness. In the first step 610, the reference property data is generated from iterative methods implemented in Thermodynamic Property Generators. Such reference property data may contain anomalous data points 410, 502, 503 as shown in FIGS. 4A and 4B. In the second step 620, the reference property data is analyzed to identify the anomalous data points. In the third step 630, anomalous data points are eliminated from the data set and replaced with suitable estimated values that better match the expected physical properties of the refrigerant fluid using domain-informed knowledge. The result of step 630 is a cleaned anomaly-free property data set. Finally, the cleaned anomaly-free property data set is used to construct non-iterative property function models using interpolatory methods in the step 640.

A visual inspection of FIG. 4A reveals that anomalies are concentrated in a relatively small region of P-h diagram. However, anomalies occur at arbitrary locations as seen in FIG. 4B. The exact locations of anomalies cannot be determined a priori in an analytical manner. Accordingly, some embodiments are based on realization that an approach for identifying anomalous data points should analyze statistical metrics, i.e., numerical measures directly calculated from the reference property data.

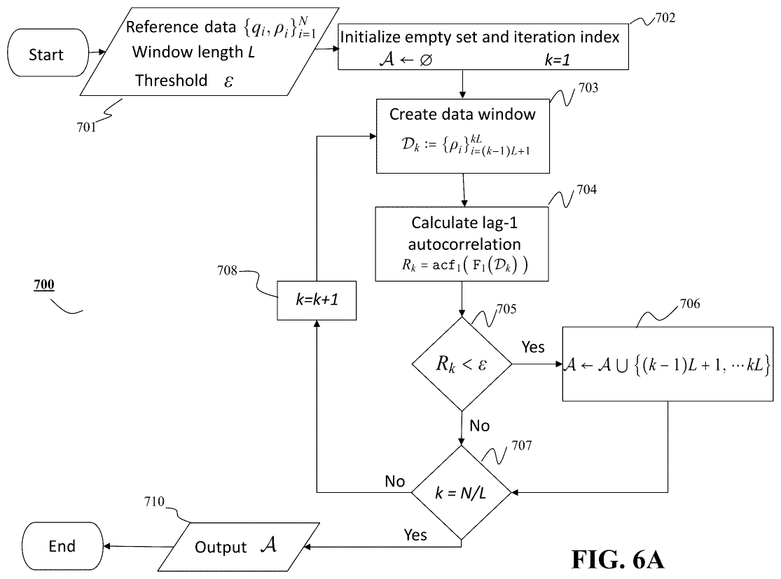

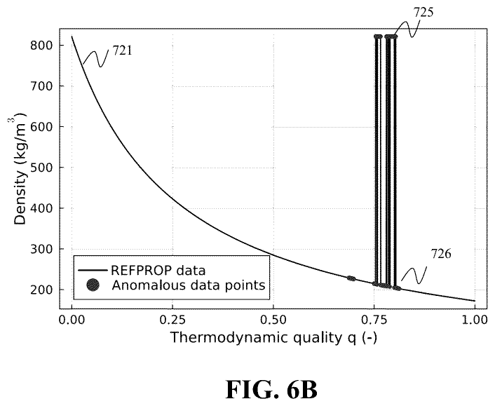

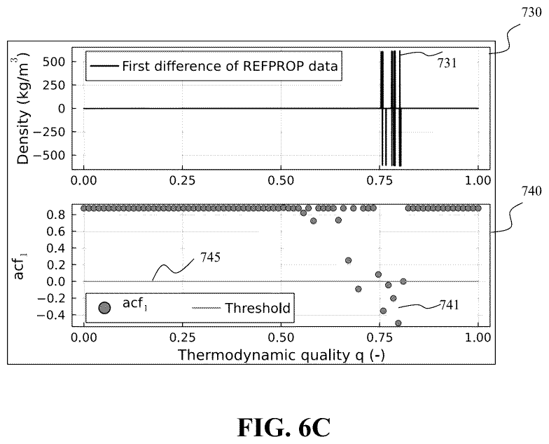

Accordingly, in an embodiment of the present disclosure, anomalous data points are identified via analyzing lag-1 autocorrelation of the reference property data. FIG. 6A describes such an algorithm 700 to identify anomalous data points from the reference property data corresponding to the step 620 in FIG. 5. The inputs 701 of this algorithm 700 include the anomalous reference data series

$${\{ {q}_{i} , {ρ}_{i} \}}_{i = 1}^{N}$$

available from a Thermodynamic Property Generator for a thermodynamic property ρ as a function of thermodynamic quality q, i.e., ρᵢ=ρ(q₁), due to the fact that q is normalized between 0 and 1, though ρᵢ can also be calculated directly from pressure Pᵢ and specific enthalpy hᵢ. The quality values are assumed to uniformly spaced within the interval [q₁, q_{N}]. The other inputs 701 include the parameters window length L and a threshold value ϵ. In the initialization step 702, the set of anomalous data indices [symbol] is initialized as an empty set and the iteration counter is initialized to 1. This algorithm considers K non-overlapping windows or segments containing L consecutive data points of the series

$${\{ {ρ}_{i} \}}_{i = 1}^{N}$$

such that N=KL.

The first window contains the data points

$${\{ {ρ}_{i} \}}_{i = 1}^{L} ,$$

the second window contains the data points

$${\{ {ρ}_{i} \}}_{i = L + 1}^{2 L} ,$$

and so on. At the k-th iteration of the algorithm, the data window 703 contains the data points

$${𝒟}_{k} : = {\{ {ρ}_{i} \}}_{i = ( k - 1 ) L + 1}^{k L}$$

The number of data points L in a window is referred to as window length which is one of the inputs 701, and typically L«N.

In the next step 704, the lag-1 auto-correlation function (acƒ₁) of the first difference of the current data window

$${𝒟}_{k} : = {\{ {ρ}_{i} \}}_{i = ( k - 1 ) L + 1}^{k L}$$

is evaluated as follows

$${R}_{k} = a c {f}_{1} ( {F}_{1} ( {𝒟}_{k} ) ) \qquad ( 3 )$$

where F_{d}(·) denotes the d^{th} forward difference of the data series. acƒ₁ is a statistical metric and it is defined as follows for an arbitrary data series of real numbers

$$𝒵 := \{ {z}_{i} \} {}_{i = M}^{N}$$

$$a c {f}_{1} ( 𝒵 ) := \frac{{\sum }_{i = M + 1}^{N} ( {z}_{i} - \overline{z} ) ( {z}_{i - 1} - \overline{z} )}{{\sum }_{i = M}^{N} {( {z}_{i} - \overline{z} )}^{2}} \qquad ( 4 )$$

where z̅ denotes the mean of the data series.

By definition, Rₖ lies within the interval [−1, 1]. Values close to 1 indicate that the series is smoothly varying; while values close to −1 indicate that the series is jagged in the following sense: if a point is above the mean, the next point is likely to be below the mean by approximately the same amount. As a result, negative values of Rₖ indicate jagged data series with sharp increments and decrements in the data values. Some embodiments are based on the realization that if there is an outlier in a window, then its first difference will contain values that are above and below the mean by about the same amount, thus yielding a negative value Rₖ. In a practical implementation, Rₖ is compared against a specified threshold value ϵ in step 705. If Rₖ is smaller than the threshold ϵ, then all indices within the current data window

$${𝒟}_{k} := {\{ {ρ}_{i} \}}_{i = ( k - 1 ) L + 1}^{k L}$$

are appended to the set of anomalous data indices A in the step 706, i.e., if a window is found to have anomalous data, all data indices within that window are flagged as anomalous. The algorithm 700 proceeds to check 707 if it has reached the end of the input reference data. If it hasn't reached the end of the input reference data, then the iteration counter 708 is incremented by 1, and the steps 703 through 707 are performed again. When the iteration counter reaches K=NL, the iterations are stopped, algorithm exits by outputting A 710, the set of anomalous indices.

FIGS. 6B and 6C illustrate data plots obtained based on the anomaly detection algorithm 700 described in FIG. 6A. FIG. 6B shows the anomalous reference density data series 721 generated from REFPROP, as well as the anomalous data points 725, 726 identified by the algorithm 700. The top plot 730 of FIG. 6C shows the first difference of the data, whereas the bottom plot 740 shows acƒ₁ values for different data windows created in the step 703 of the algorithm 700. Sharp changes 731 in the first difference correspond to negative values 741 of acƒ₁. In this exemplary illustration, the threshold 745 is set to be ϵ=0 so that data windows with negative lag-1 autocorrelations are flagged as anomalous. These identified anomalous data points 725, 726 are as emphasized in FIG. 6B by markers.

The algorithm 700 corresponds to the step 620 of the general procedure 600 to identify anomalous data points. The output set 710 of anomalous data indices is used in the step 630 of the general procedure 600 to eliminate these anomalous data points using domain-informed knowledge.

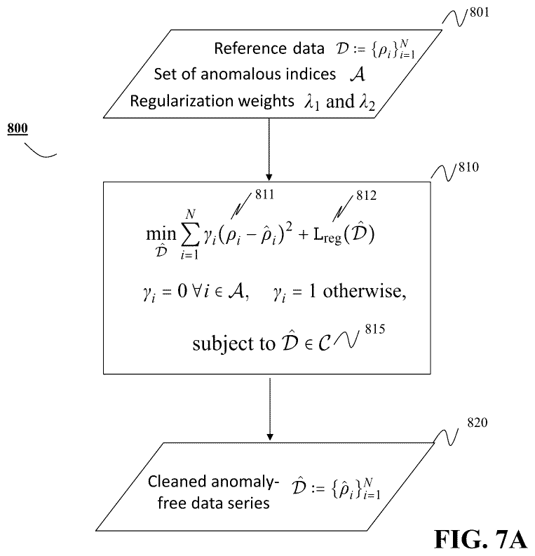

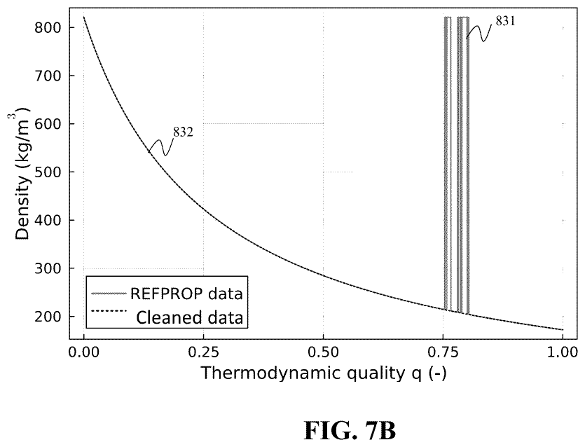

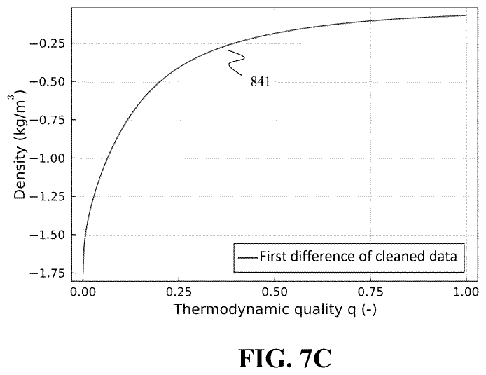

FIG. 7A describes a method 800 to eliminate anomalous data points and replace them with estimated values that better match the expected physical properties of the fluid using domain-informed knowledge; which corresponds to the step 630 of the general procedure 600. The inputs 801 to this method 800 include the anomalous reference data series

$$𝒟 := {\{ {ρ}_{i} \}}_{i = 1}^{N}$$

and the set of anomalous indices [symbol] 710 obtained from the algorithm 700. The anomalous data points are eliminated by solving the optimization 810 for a cleaned anomaly-free data series

$$\hat{𝒟} := {\{ {\hat{ρ}}_{i} \}}_{i = 1}^{N} .$$

The cost function of the optimization 810 comprises of two terms. The first term 811 is a sum of square penalty on the deviations of estimated ρᵢ from the reference ρᵢ. In term 811, the weights γᵢ corresponding to anomalous data points are set to zero, thus, penalizing the deviations corresponding to only anomaly-free data points and discounting the deviations from anomalous data points. The second term 812 L_{reg}( [symbol] ) denotes a suitable regularization penalty on [symbol] . As the first and second derivatives of thermodynamic properties are often used in the formulation of the mass and energy conservation equations, and are thus used by differential equation solvers to advance simulations from an initial condition, the derivatives must exhibit some degree of smoothness and be free of sharp discontinuities except on the saturation curves. Accordingly, some embodiments are based on the realization that the smoothness can be induced on the derivatives by defining L_{reg} ( [symbol] ) to be a measure of roughness, as follows,

$${L}_{reg} ( \hat{𝒟} ) = {λ}_{I} \tilde{R} ( {F}_{1} ( \hat{𝒟} ) ) + {λ}_{2} \tilde{R} ( {F}_{2} ( \hat{𝒟} ) )$$

where \tilde{R} denotes roughness of a data series and the two terms denote roughness of first and second difference of [symbol] weighted by the weights λ₁ and λ₂. The weights λ₁ and λ₂ are inputs 801 to the method 800. As the integral of the squared second derivative is conventionally used as a measure of the roughness of a curve, we analogically use an equivalent measure of roughness for a discrete series

$$\tilde{R} ( 𝒵 ) = {\sum }_{i = 1}^{N - 2} {( {z}_{i}^{″} )}^{2}$$

$$Where {𝒵}^{″} = {\{ {z}_{i}^{″} \}}_{i = 1}^{N - 2} = {F}_{2} ( 𝒵 ) .$$

Some embodiments are based on the realization that noise in the reference data, even if small in the magnitude, may lead to physically inconsistent derivatives of the data. For example, based on physical laws, density must be monotonically decreasing function of thermodynamic quality in the two-phase region. Small noise may lead to local violation of monotonicity constraint and lead to physically inconsistent property functions. Accordingly, some embodiments are based on the realization that physics-based constraint should be explicitly incorporated in the optimization problem. To this end, any physics-informed constraints on derivatives of data series can be explicitly incorporated in the optimization problem by specifying the constraint cone [symbol] 815. Such constraints can originate from fundamental physical laws and/or they can be inferred from anomaly-free reference data. For instance, such constraints for density include F₁( [symbol] )<0, F₂( [symbol] )>0, F₃ ( [symbol] )<0, and F₄( [symbol] D)>0. By incorporating these constraints, it is ensured that the cleaned data is consistent with the other anomaly-free data generated by iterative methods in terms of monotonicity and the convexity/concavity of the properties and their derivatives curves. One advantageous aspect of this data cleaning approach is that the optimization problem 810 is a quadratic program (QP) subject to linear constraints, and as such can be efficiently solved using specialized QP solvers as well as some general-purpose optimization solvers. The output 820 of this method 800 is the cleaned anomaly-free data series

$$\hat{𝒟} := {\{ {\hat{ρ}}_{i} \}}_{i = 1}^{N}$$

that satisfies physical constraints.

FIGS. 7B, 7C and 7D further illustrate results of anomaly elimination method 800 described in FIG. 7A. FIG. 7B shows the reference property data series generated from REFPROP at an exemplary pressure 3.015 MPa which contains anomalous data points 831. The curve 832 shows the cleaned anomaly-free data series obtained from the method 800 by solving the optimization 810. The curve 841 in FIG. 7C shows first difference of the cleaned anomaly-free data series. The curve 841 is evidently smooth and free of sharp variations in the derivatives of the data series indicating that there are no abrupt changes in the underlying data.

The method 800 describes the approach for cleaning an anomalous data series

$${\{ {q}_{i} , {ρ}_{i} \}}_{i = 1}^{N}$$

of a thermodynamic property ρ as a function of thermodynamic quality q, i.e., ρᵢ=ρ(q₁), at some constant pressure. In order to construct propery function over a broad operating ranges of pressure and specific enthalpies, reference data series are typically generated at various values of constant pressures giving a two-dimensional reference data matrix such as shown illustrated in FIG. 3. This matrix can be partitioned in terms of its rows as follows

$$ℳ = [ \begin{matrix}{M}_{1} \\ . \\ . \\ {M}_{M}\end{matrix} ]$$

Where jth row [symbol] is a reference data series at a constant pressure Pⱼ.

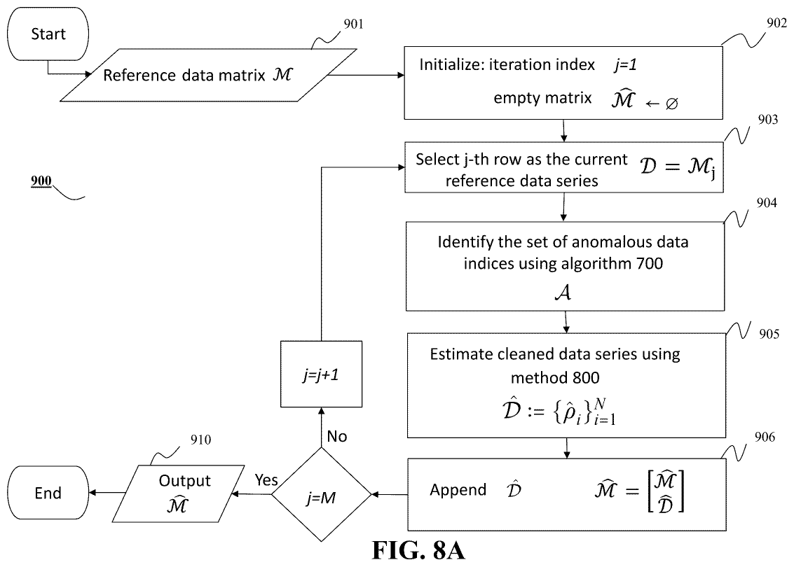

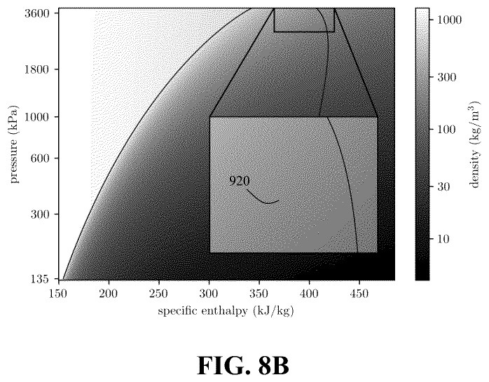

FIG. 8A describes a method 900 for estimating cleaned data matrix [symbol] from a reference data matrix [symbol] which contains anomalous data points. Anomalous data matrix [symbol] is an input 901 to this method. The iteration index is initialized to 1 and an empty matrix [symbol] is created in the step 902. The method proceeds by selecting the j-th row [symbol] as the data series to be cleaned in the step 903. The set of anomalous data indices [symbol] is identified using algorithm 700 in 904. This set [symbol] is used in the next step 905 to eliminate the anomalies and estimate the cleaned data series [symbol] using method 800. This cleaned data series is appended as a row of the matrix [symbol] in the following step 906. These iterations are repeated for all M rows of the reference data matrix [symbol] . When all rows of [symbol] are cleaned, i.e., j=M, the method 900 ends with [symbol] as the output 910.

FIG. 8B further demonstrates the efficacy of this cleaning method 900 on the same reference data as was used to generate FIG. 3. The anomalies clearly present in the reference data over the entire P-h domain have been eliminated, as suggested by the comparison between the inset in FIGS. 3 and 8B. The reference and target densities at 3.785 MPa for q E [0,1] illustrate the much smoother behavior of the target density. The values of the target data over the region in the inset 920 are estimated and may slightly differ from the non-anomalous reference data, but these curves manifest physically realistic characteristics (e.g., smoothness of derivatives) that are not exhibited by the reference data and are therefore more useful in a practical context.

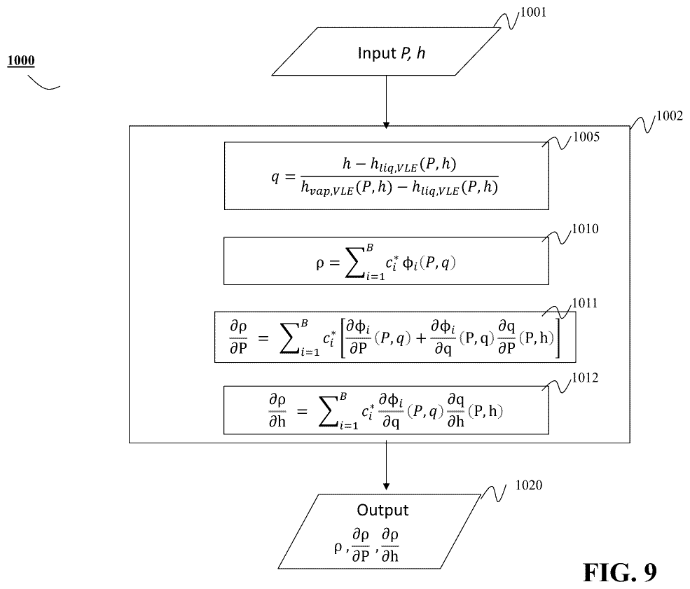

FIG. 9 illustrates an exemplary thermofluid property function 1000 to calculate a thermodynamic property p, e.g., density, from two thermodynamic variables P and h, which are inputs 1001. The (P, h) pair is transformed to (P, q) pair using the transformation 1005 defined in equation (1). Subsequently, the thermodynamic property ρ and its partial derivatives

$$\frac{\partial ρ}{\partial P} and \frac{\partial ρ}{\partial h}$$

with respect to the inputs 1001 are calculated using the interpolation functions 1010, 1011, 1012 and given as the output 1020. A general procedure for constructing interpolation functions 1010, 1011, 1012 is described below.

The cleaned data matrix [symbol] which is the output 910 of method 900, represents data for a thermodynamic property p, sampled over a two-dimensional domain. This matrix contains MN data points, where M is the number of rows in [symbol] i.e., the number of different pressure values at which data was generated, and N is the number of columns in [symbol] , i.e., the number of grid points for thermodynamic quality q axis. The objective of the interpolation function is to model the thermodynamic variable ρ as follows

$$ρ = {\sum }_{b = 1}^{B} {c}_{b} {ϕ}_{b} ( P , q )$$

Where ϕ_{b}(P, q) are known bivariate functions which map two input variables P and q to a real scalar output. These functions ϕ_{b}(P, q), referred to as basis functions, must be specified before the interpolation is constructed. Polynomial functions are one of the most common choices for the basis function as they can satisfy accuracy, continuity and smoothness requirements within a specified domain by selecting polynomials of suitable order. Thus, an interpolation can be constructed by specifying bivariate polynomial functions as the basis functions ϕ_{b}(P, q).

The coefficients c_{b} are unknown and are determined by solving the following least squares problem in terms of optimization variables

$${\{ {c}_{b} \}}_{b = 1}^{B}$$

$${\{ {c}_{b}^{*} \}}_{b = 1}^{B} = arg min {\sum }_{i}^{M} {\sum }_{j}^{N} ( {\hat{M}}_{ij} - {\sum }_{b = 1}^{B} {c}_{b} {ϕ}_{b} ( {P}_{i} , {q}_{j} ) )$$

Where [symbol] denotes the i-j element of the matrix [symbol] .

Once the optimal coefficients c*_{b} are determined, an interpolation function is constructed as follows.

$$ρ = {\sum }_{i = 1}^{B} {c}_{i}^{*} {ϕ}_{i} ( P , q ) \qquad ( 5 )$$

Which is the interpolation function 1010. The optimal coefficients characterize the fluid property data of a fluid flowing in the vapor compression system.

Controller/optimizers often make use of partial derivatives of properties with respect to input variables; which can be calculated from the interpolation as follows

$$\frac{\partial ρ}{\partial P} = {\sum }_{i = 1}^{B} {c}_{i}^{*} [ \frac{\partial {ϕ}_{i}}{\partial P} ( P , q ) + \frac{\partial {ϕ}_{i}}{\partial q} ( P , q ) \frac{\partial q}{\partial P} ( P , h ) ] \qquad ( 6 )$$

$$\frac{\partial p}{\partial h} = {\sum }_{i = 1}^{B} {c}_{i}^{*} \frac{\partial {ϕ}_{i}}{\partial q} ( P , q ) \frac{\partial q}{\partial h} ( P , h ) \qquad ( 7 )$$

where expressions for

$$\frac{\partial ρ}{\partial P} and \frac{\partial ρ}{\partial h}$$

and are derived by applying chain rule of differentiation. Since ϕᵢ(P, q) are known polynomial basis functions of P and q, and q(P, h) is a known function of P and h defined in equation (1), partial derivatives

$$\frac{\partial {ϕ}_{i}}{\partial P} , \frac{\partial {ϕ}_{i}}{\partial q} , and \frac{\partial q}{\partial P} , \frac{\partial ρ}{\partial h}$$

required in equations (6) and (7) the are readily derived as analytical expression in terms of input variables P and q.

FIG. 10 is a block diagram of a controller/optimizer circuit 1700 that includes a digital computer including the thermofluid property function calculator 1705 according to some embodiments of the present disclosure.

The figure illustrates a vapor compression cycle (system) 1711 is connected to the controller 1700 via sensors 1709 and actuators 1710. In some cases, the controller circuit 1700 includes an input interface 1707 connected to the sensors 1709, an output interface 1708 connected to the actuators 1710, a processor 1701, a storage 1702 and a memory unit 1706. The storage 1702 can store data 1703, a computer-implemented controller program 1704 and a thermofluid property calculator (program) 1705.

The thermofluid property calculator 1705 may include program that implements thermofluid property function 1000 as a computer-executable program. The data 1703 can include the optimal coefficients c*_{b} used in construction of interpolation functions 1010, 1011, 1012. Additionally or alternatively, the computer-implemented controller program 1704 can include a thermofluid property calculator, and an Interpolation Function Calculator that implements any or all interpolation functions 1010, 1011, 1012 as a computer-executable programs.

The input interface 1707 is configured to receive/acquire measurement data from the sensors 1709, and the output interface 1708 is configured to transmit control signals/commands to the actuators 1710 to operate the actuators according to the control parameters (control data) computed based the controller program 1704 using the processor 1701. In some cases, the input interface 1707 and the output interface 1708 may be integrated into a input/output interface.

The vapor compression system 1711 includes valves, compressor, and heat exchangers. In some cases, the vapor compression system 1711 may include variable actuators and also incorporates a controller 1700 that regulates their behavior. The vapor compression cycle (system) 1711 can be configured in a manner similar to the vapor compression system 102 in FIG. 1, which includes, at a minimum, a set of four components, a compressor 103, a condensing heat exchanger 104, an expansion device 106, and an evaporating heat exchanger 107. Heat transfer from the condensing heat exchanger is promoted by use of fan 105, while heat transfer from the evaporating heat exchanger 107 is promoted by the use of fan 108. This system 1711 may include variable actuators that are configured to be used by a controller, such as a variable compressor speed, variable expansion valve position, and variable fan speeds. Of course, there are many other alternate equipment architectures to which this disclosure pertains with multiple heat exchangers, compressors, valves, and other components such as accumulators or reservoirs, pipes, and so forth, and the discussion of a simple vapor compression cycle is not intended to limit the scope or application of this disclosure to systems whatsoever. In the disclosure, the equipment is dynamically controlled by instruction commands (digital command data/electrical control signals) that are transmitted from the controller via an output interface 1708. The equipment may be referred to as actuators, such as expansion devices, fans, compressors, valves, etc.

The input and output interfaces 1707 and 1708 provide the facility of exchanging data between the various components of the controller 1700, including processor 1701, storage 1702 with data 1703, controller 1704, and property calculator 1705, and memory 1706. The input and output interfaces may include a communication infrastructure such as a controller area network (CAN) bus or other medium that allows data to be physically transferred through serial or parallel communication channels (e.g., copper, wire, optical fiber, computer bus, wireless communication channel, etc.).

In an embodiment, values of measurements of temperatures or pressures at specific places in the cycle, e.g., 109, 110, 111, or 112, are obtained by sensors 1709 and then transmitted over a communication channel and converted into a computer-readable form in the input interface 1707. This computer-readable representation of the input thermofluid properties from the input interface 1707 is then used by the processor 1701 along with the data 1703 and property calculator 1705 to calculate fluid properties via the embodiments described in this work from the information obtained from the input interface. The processor then uses these calculated fluid properties to determine updated values for the system actuators, such as a compressor 103, valve position 106, or fan motor speeds 105 or 108 from the controller 1704. These values are then converted from a computer readable form to the electronic form suitable for interfacing to the physical system by the output interface 1708, and are transmitted to the electronic hardware controlling the actuators by a similar communication channel used by the input interface. The electronic hardware controlling the actuators may include a power electronic drive for commanding the voltages and currents needed to drive the compressor motor or fan motors at specific speeds, or may include commands needed to send a stepper motor in the expansion valve to a specific position. These actuators then change their operating conditions according to these inputs from the controller 1700 and output interface 1708. In some cases, the input interface and the output interface may be integrated as a data interface or a signal interface.

The above-described embodiments of the present disclosure can be implemented using hardware, software, or a combination of hardware and software.

Also, the embodiments of the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

We claim:

1. A control system for controlling a vapor compression system having a multicomponent refrigerant mixture and actuators, comprising:
an input interface configured to receive setpoints of the vapor compression system from a user input and measurement data from sensors arranged in the vapor compression system;
a memory configured to store fluid property data of a fluid flowing in the vapor compression system and computer-executable programs including a thermofluid property calculator and an interpolation function calculator, where the thermofluid property calculator and interpolation function calculator are constructed by
generating reference thermodynamic property data;
identifying anomalous data points in the reference thermodynamic property data;
cleaning the reference thermodynamic property data by one or a combination of eliminating the anomalous data points and replacing the anomalous data points with estimated values matching expected physical properties of the fluid to obtain cleaned anomaly-free thermodynamic property data; and
calculating optimal coefficients with respect to the cleaned anomaly-free thermodynamic property data; and
a processor configured to:
compute, with respect to the setpoints, a pair of input thermofluid property variables from the measurement data or from the stored fluid property data;
compute a third thermofluid property variable using the interpolation function calculator;
compute derivatives of the third thermofluid property variable with respect to the pair of input thermofluid property variables using the interpolation function calculator;
compute control data from the measurement data and the third thermofluid property variable and the derivatives of the third thermofluid property variable; and
transmit, via an output interface, the computed control data including instructions that control the actuators operating the vapor compression system to the vapor compression system.

2. The control system of claim 1, wherein the interpolation function calculator uses specified basis functions, and optimal coefficients calculated for the specified basis functions.

3. The control system of claim 1, wherein the reference property data that contain the anomalous data points of various magnitudes is generated using a Thermodynamic Property Generator.

4. The control system of claim 3, wherein the anomalous data points are identified by analyzing statistical metrics of the anomalous data.

5. The control system of claim 3, wherein the anomalous data points are eliminated and replaced by solving a quadratic program subject to linear constraints that enforce domain-informed knowledge.

6. The control system of claim 3, wherein the optimal coefficients are calculated by solving a least squares problem with respect to the cleaned anomaly-free thermodynamic property data.

7. The control system of claim 1, wherein the interpolation function calculator uses bivariate polynomials as basis functions.

8. The control system of claim 1, wherein the actuators are compressors, valves, and fans.

9. The control system of claim 1, wherein a saturation curve is configured to divide a region of interest into a two-phase region and a single-phase region with respect to the fluid.

10. A non-transitory computer readable medium storing computer-executable programs including instructions that, when executed by a processor, causes a controller connected to a vapor compression system having multicomponent refrigerant mixture and actuators through input and output interfaces, to:
receive, via the input interface, setpoints of the vapor compression system from a user input and measurement data from sensors arranged in the vapor compression system;
compute, with respect to the setpoints, a pair of input thermofluid property variables from the measurement data or from fluid property data stored in a memory;
compute a third thermofluid property variable using an interpolation function calculator constructed by
generating reference thermodynamic property data;
identifying anomalous data points in the reference thermodynamic property data;
cleaning the reference thermodynamic property data by one or a combination of eliminating the anomalous data points and replacing the anomalous data points with estimated values matching expected physical properties of the fluid to obtain cleaned anomaly-free thermodynamic property data; and
calculating optimal coefficients with respect to the cleaned anomaly-free thermodynamic property data;
compute derivatives of the third thermofluid property variable with respect to the pair of input thermofluid property variables using the interpolation function calculator;
compute control data from the measurement data and the third thermofluid property variable and the derivatives of the third thermofluid property variable; and
transmit, via the output interface, the computed control data including instructions that control the actuators operating the vapor compression system to the vapor compression system.

11. The non-transitory computer readable medium of claim 10, wherein the interpolation function calculator uses specified basis functions, and optimal coefficients calculated for the specified basis functions.

12. The non-transitory computer readable medium of claim 10, wherein the interpolation function calculator is constructed using a Thermodynamic Property Generator.

13. The non-transitory computer readable medium of claim 10, wherein the anomalous data points are identified by analyzing statistical metrics of the anomalous data.

14. The non-transitory computer readable medium of claim 10, wherein the anomalous data points are eliminated and replaced by solving a quadratic program subject linear constraints that enforce domain-informed knowledge.

15. The non-transitory computer readable medium of claim 10, wherein the optimal coefficients are calculated by solving a least squares problem with respect to the cleaned anomaly-free thermodynamic property data.

16. The non-transitory computer readable medium of claim 10, wherein the interpolation function calculator uses bivariate polynomials as basis functions.

17. The non-transitory computer readable medium of claim 10, wherein the actuators are compressors, valves, and fans.

18. The non-transitory computer readable medium of claim 10, wherein a saturation curve is configured to divide a region of interest into a two-phase region and a single-phase region with respect to the fluid.
